(19) United States
(12) Patent Application Publication
(10) Pub. No.: US 2016/0284445 A1
(43) Pub. Date: Sep. 29, 2016

(54) ENERGY EFFICIENT COPPER WIRE PRODUCTION SYSTEM

(71) Applicant: Qiu Yi Lee, Hong Kong (HK)

(72) Inventor: Qiu Yi Lee, Hong Kong (HK)

(73) Assignee: Y GENERATION TECHNOLOGIES COMPANY LIMITED, Hong Kong (HK)

(21) Appl. No.: 14/672,095

(22) Filed: Mar. 28, 2015

(51) Int. Cl. H01B 13/00; B01D 53/86; C23C 30/00

(52) U.S. Cl. CPC H01B 13/0026; C23C 30/00; B01D 53/86

(57) ABSTRACT

Systems are provided for processing copper wires. In one embodiment, a system for processing copper with coating material is provided. The system employs a housing, an input interface for receiving copper wires, and an output interface for receiving copper wires. In one embodiment, both the input interface and the output outface are connected to the housing. Furthermore, an evaporation zone, a solid-state area, and a combustion chamber may be disposed in the housing. The evaporation zone is connected to the input interface, and the solid-state area is connected to the output interface. The combustion chamber processes gases produced in the evaporation zone. Three returning pipes are provided, each being connected to the exhaust gas tube for directing processed gases to other components of the system.

### FIELD OF THE INVENTION

The present invention relates to systems for processing wires, particularly to a heating process for producing copper wires in an environmentally friendly way.

### BACKGROUND OF THE INVENTION

Copper-coated wires exhibit good electrical conductivity, high thermal conductivity, low contact resistance and low density. In the manufacturing process, raw material copper needs to undergo a heating process before layers of coating material can be applied to the thereto and before the copper-coated wires are finalized.

During the heating process, a large volume of vapor, gaseous waste, and other harmful pollutants may be emitted into the air, land, water which may be detrimental to human health and the environment. Currently, there is a strong push for manufacturers to produce manufacturing goods with high efficiency in order to reduce environmental pollution. The target of such effort is to take advantage of unused or wasted energy.

As a result of mounting pressure from NGO's and governmental entities worldwide, manufacturers are seeking ways to promote energy reuse. Therefore, there is an unfulfilled need in the art to produce copper-coated wires with a higher efficiency while reducing negative impact on the environment.

### SUMMARY OF THE INVENTION

Systems and/or methods are provided for processing copper wires. In one embodiment, a system for processing copper with coating material is provided. The system employs a housing, an input interface for receiving copper wires, and an output interface for receiving copper wires. In one embodiment, both the input interface and the output outface are connected to the housing. Furthermore, an evaporation zone, a solid-state area, and a combustion chamber may be disposed in the housing. The evaporation zone is connected to the input interface, and the solid-state area is connected to the output interface.

The combustion chamber processes gases produced in the evaporation zone. In one embodiment, an exhaust gas tube is included in the housing. The exhaust gas tube is used to direct the processed gases from the combustion chamber. Three returning pipes may be provided, each being connected to the exhaust gas tube for directing processed gases to other components of the system. The first returning pipe may be connected to the exhaust gas tube directing the processed gases to the combustion chamber. A second returning pipe may be connected to the exhaust gas tube directing the processed gases to the evaporation zone. A third returning pipe may be connected to the exhaust gas tube directing the processed gases to the solid-state area.

In one embodiment, the system further utilizes an airflow director for directing the processed gases from the combustion chamber to the exhaust gas tube. In this embodiment, an exhaust pipe is mounted on top of the housing and connected to an exhaust gas collecting area. An air concentrator (132) may be installed in the exhaust gas collecting area. A heating layer (133) is mounted on a surface of the air concentrator (132) conducting heat transfer between the air concentrator (132) and the processed gases. In a further embodiment, the system has a steam generator (134) attached to the air concentrator (132). A water tank (135) may also be attached to the steam generator (134). A vapor output pipe (136) is attached to the steam generator (134); and a vapor balancing pipe (137) is attached to the water tank (135).

In some implementations, the water tank employs alarm features. In one example, the water tank has a tank level alarm device. The water tank may also have a drainage system for preventing liquid overflow. The drainage system may also have a floating element mounted on a side in the water tank and a switch to control engagement of the water tank.

Other cooling features may also be provided. In one embodiment, the housing further includes an air cooling area that is a confined, isolated space within the housing. The air cooling area may have a warm air outlet (141) installed on a side of the input interface. To conduct heat transfer with a cool air circulating pipe, a gas exhaust pipe is mounted on a top side of the housing. Further in this embodiment, a hot air duct is provided that serves as a connection between the cool air circulating pipe and the hot air duct. In yet another embodied example, the hot air duct includes at least one electric heater and at least one heat sensor.

Exhaust treatment features may additionally be provided in one or more embodiments of the disclosed technology. In one embodiment, the housing has an exhaust treatment system. The system uses the combustion chamber, the exhaust pipe, and a sub-system. The sub-system is included in the combustion chamber that along with a heating pipe, and a catalytic combustion tank. The entryway of the catalytic combustion tank may be a catalytic tank door. The catalytic combustion tank may also have an air filter and a catalytic combustion block that includes air circulation gap for airflow circulation. Further in the embodiment, an exhaust pipe is included to serve as a connection between the combustion chamber and the catalytic combustion tank.

### BRIEF DESCRIPTION OF THE DRAWINGS

FIG. 1 illustrates a block diagram of a housing included in the present system in accordance with embodiments of the present invention.

FIG. 2 exemplifies a structural diagram of an embodied system, in accordance with the embodiments of the present invention.

FIG. 3 exemplifies a schematic diagram of exhaust recovery system, in accordance with the embodiments of the present invention.

FIG. 4 exemplifies a schematic diagram of a catalytic combustion tank, in accordance with the embodiments of the present invention.

FIG. 5 is a high-level block diagram of a microprocessor device that may be used to carry out the disclosed technology.

### DETAILED DESCRIPTION

References will now be made in detail to the present exemplary embodiments, examples of which are illustrated in the accompanying drawings. Whenever possible, the same reference numbers will be used throughout the drawings to refer to the same or like parts.

Referring now to the figures, systems, apparatuses, methods and devices are provided for safely processing copper with coating material while reducing environmental impacts and energy waste. The system uses a housing, an input interface for receiving copper wires, and an output interface for receiving copper wires. In one embodiment, both the input interface and the output outface are connected to the housing. Furthermore, an evaporation zone, a solid-state area, and a combustion chamber may be disposed in the housing. The evaporation zone is connected to the input interface, and the solid-state area is connected to the output interface. The combustion chamber processes gases produced in the evaporation zone. Three returning pipes are provided, each being connected to the exhaust gas tube for directing processed gases to other components of the system

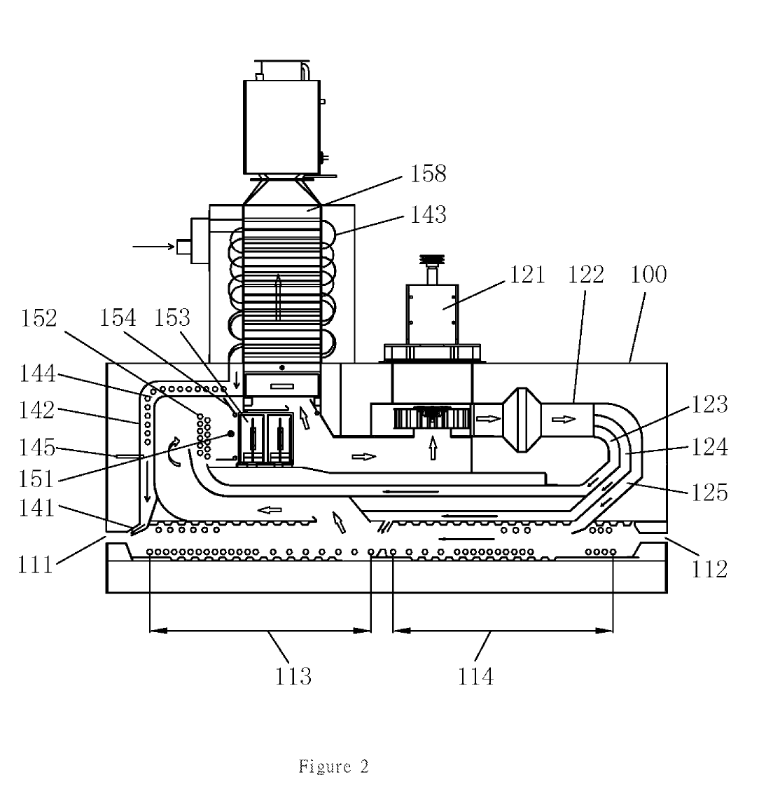

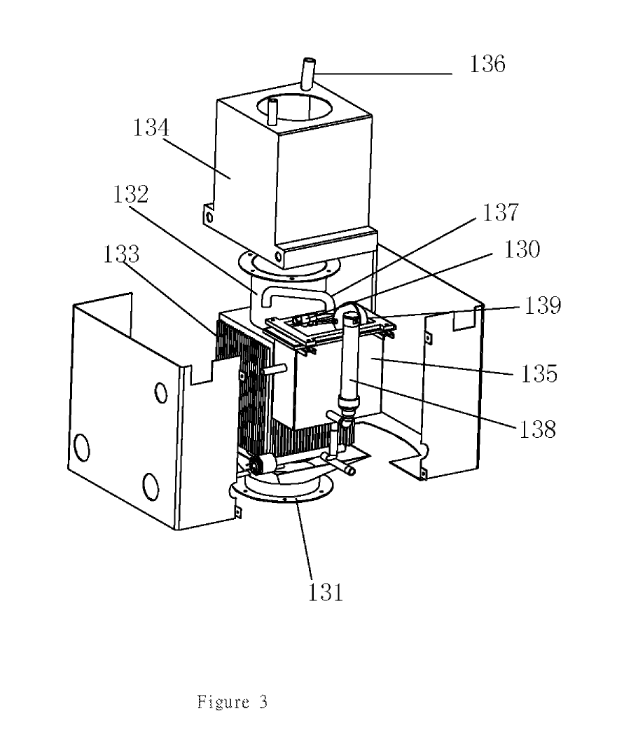

Referring explicitly to FIG. 2, a structural diagram is exemplified of an embodied system, in accordance with the embodiments of the present invention. Further, FIG. 3 exemplifies a schematic diagram of exhaust recovery system, in accordance with the embodiments of the present invention. In both FIGS. 2 and 3, a housing 100 is depicted in a system for processing copper with coating material, consistent with the embodiments of the present invention. Housing 100 may be implemented with or without a frame, and may be made of any material. Housing 100 is used to serve as a foundation or a frame, facilitating the cohesion of different parts of the system. An input interface (111), which may be configured as an input pipe, a port, or an entry point, is connected to the housing (100), for receiving a copper wire. Housing 100 is also connecting to an output interface (112) for sending out the processed copper wire. Output interface may be implemented as an output pipe, port, or a duct where the copper wire is processed or finished.

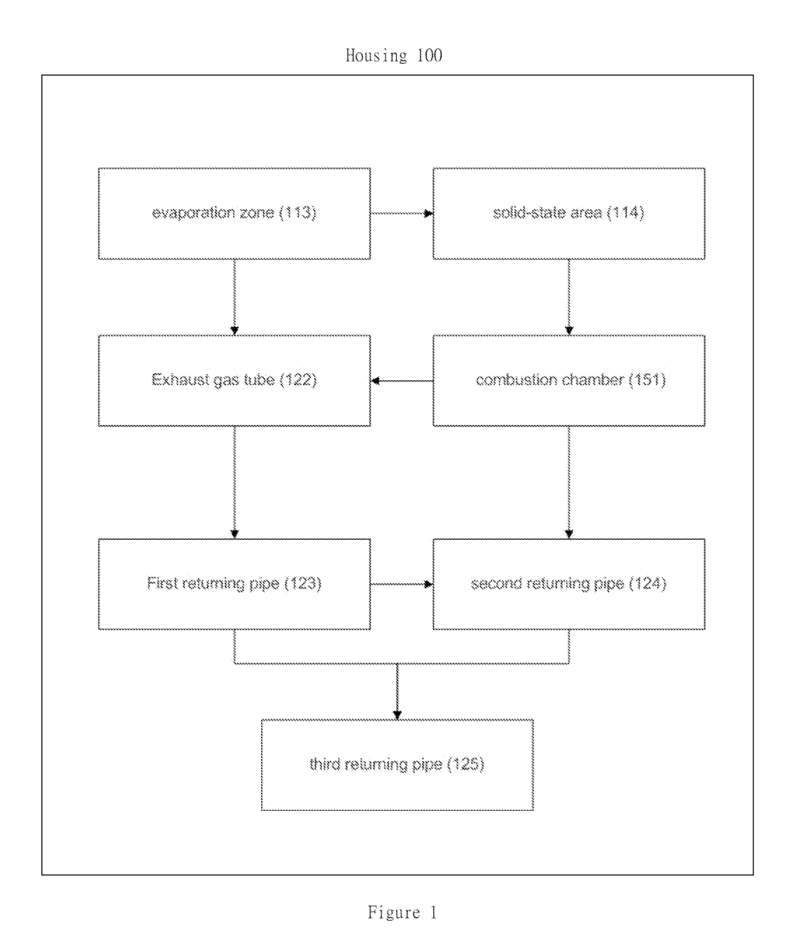

Referring now to FIG. 1, a block diagram is illustrated showing a housing included in the present system in accordance with embodiments of the present invention. Connected to the input interface (111) is an evaporation zone (113). As part of the copper coating process, the evaporation zone (113) allows copper material to achieve a certain high temperature. After going through the heating process in the evaporation zone (113), the heated copper material is then passed to the solid-state area (114) that is connected to the output interface.

Gases, which may be exhaust air, are produced in a combustion chamber (151) included in the housing 100. The gases produced then go through an exhaust gas tube (122) included in the housing. In the present invention, the exhaust gas does not simply go out of the exhaust pipes, as seen commonly in the industry. Instead, the exhaust gas is reused and/or recycled to provide heat and/or energy to the present inventive system in different ways. One use is to take advantage of the heat and/or power remaining in the exhaust gas to generate power in the combustion chamber 151. This can be done via a first returning pipe (123) being connected to the exhaust gas tube 122, directing the processed gases to the combustion chamber 151. Less energy consumption would then be required to be provided to the combustion chamber 151, thereby increasing overall energy efficiency. Similarly, a second returning pipe (124) may be used to direct exhaust gas by connecting the second returning pipe 124 to the exhaust gas tube thereby directing the processed gases to the evaporation zone. Moreover, a third returning pipe (125) may be connected to the exhaust gas tube for directing the processed gases to the solid-state area. Here, the number of components, subsystems, and/or devices may be connected or extended to the exhaust gas tube 122 to take advantage of the heat contained in the exhaust gas.

An additional feature to the current inventive system, air flow of the exhaust gas may be directed to the various units using an airflow director, such as, for example, a turbine or a fan. As an example, the inventive system may use an airflow director to direct the processed gases from the combustion chamber to the exhaust gas tube. Similarly, such an airflow director may be used to direct air flow from the exhaust gas tube to the evaporation zone and/or the solid-state area.

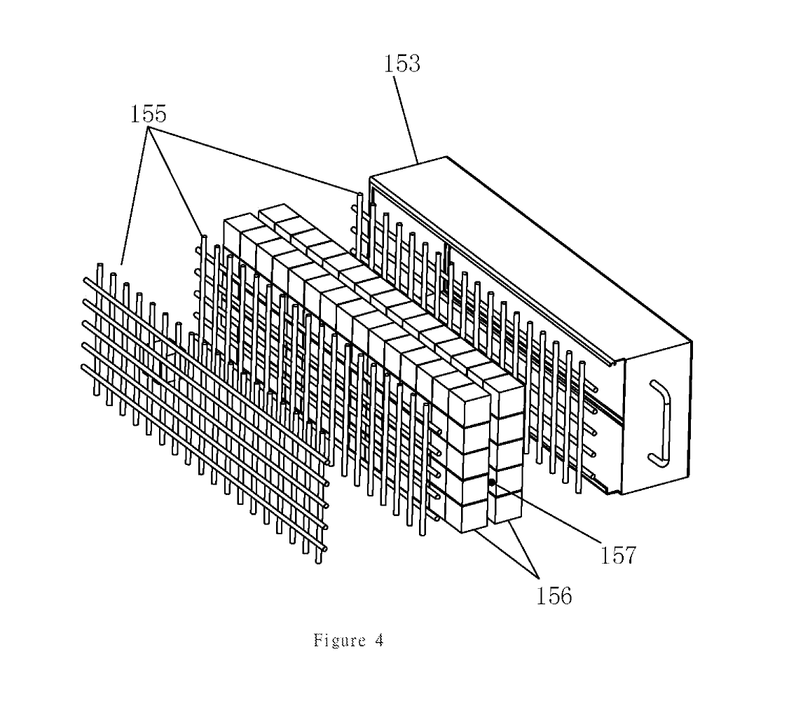

FIG. 4 exemplifies a schematic diagram of a catalytic combustion tank, in accordance with the embodiments of the present invention. For releasing reused exhaust gas out of the inventive system, an exhaust pipe (158) mounted on top of the housing is provided. Referring to FIGS. 2 through 4, an exhaust pipe 158 is connected to an exhaust gas collecting area (131), which is further connected to an air concentrator (132). On the surface of air concentrator (132), a heating layer (133) may be used to conduct heat transfer between the air concentrator (132) and the processed gases. As is known in the art, a steam generator (134), a water tank (135), a vapor output pipe (136), steam generator (134), and/or a vapor balancing pipe (137) may be used to drain the reused exhaust gas out of the system.

Furthermore, a common problem may be liquid overflow in the present inventive system. As such, a drainage system is disclosed for preventing the overflow from occurring. To detect the current level of liquid in the water tank, the drainage system employs a floating element (139) mounted on a side of the interior of the water tank and a switch to control engagement of the water tank. If it is detected that overflow of liquid in the water tank is happening, the switch may be engaged to control the overflow in the tank.

In use, after being finalized and installed into a furnace from the left end, the copper has the electrical effect of the heating furnace. The tube may be in a high temperature state during the drying of the coated wire. Likewise, the furnace may be experiencing high-temperature gas flow. A part of the solvent is found after the end portion of the gas suction portion.

The central inlet into the catalyst combustor, the other portion of the gas through the entire furnace after one end portion of the intake port enters the catalytic combustor of the furnace, and four catalytic combustion instances cause a lot of heat to be generated by the radiation plate at the bottom of the furnace in uniform radiation. This process serves to maintain the temperature of hot air evenly. Hot air flows into the suction chamber after catalysis. Evaporation of the solvent occurs generally along a triangular flow gradient multi-channel air distribution device. The air flows from the left and right sides of the air intake into the solvent-evaporated stream after the stream channel partition plate splits into the exhaust pipe. The flow is drawn by the blower gas into the heat exchange using the hot air circulation device. A discharge outlet of the device leads directly to the atmosphere. The outlet portion of the heat leads directly into another heat exchange chamber. This is carried out using an internal uniform wind producing device or set of devices. The end of the heat exchange chamber communicates with the catalytic combustion zone near the inlet channel. A fan is used to blow cold air to lower the temperature. The fan directs hot airflow into the hot solvent steam flow path within the interior and facilitates airflow entry through the electric heating tube heat exchange chamber. Further, the airflow is diverted away from the middle of one end of the catalytic combustion zone if the air temperature is too low for heating. This is to ensure that the heat exchange of indoor air flow and heat achieve a proper balance.

A cooling area is disclosed, as it may be used to cool down certain areas within the system. Specifically, it can be implemented as an isolated, confined area. The air cooling area comprises a warm air outlet (141) installed on a side of the input interface; a gas exhaust pipe (158) mounted on top side of the housing conducting heat transfer with a cool air circulating pipe (143); and a hot air duct (142) forming a connection between the cool air circulating pipe and the hot air duct. The hot air duct (142) includes a heater (144) and a heat sensor. The heater 144 is not limited to electric heater and can be extended to other forms of heat generators. Heat sensor is merely referred to a sensor that is sensitive to heat latent in the system.

An exhaust treatment system is disclosed in the present invention. Such a system may typically use the combustion chamber (151), the exhaust pipe (158), and a sub-system included in the combustion chamber (151) that includes a heating pipe 152, and a catalytic combustion tank 153. The catalytic combustion tank 153 may include a catalytic tank door 154, an air filter 155 and a catalytic combustion block having an air circulation gap 157 for airflow circulation. An exhaust pipe is also included to connect the combustion chamber (151) and the catalytic combustion tank 153.

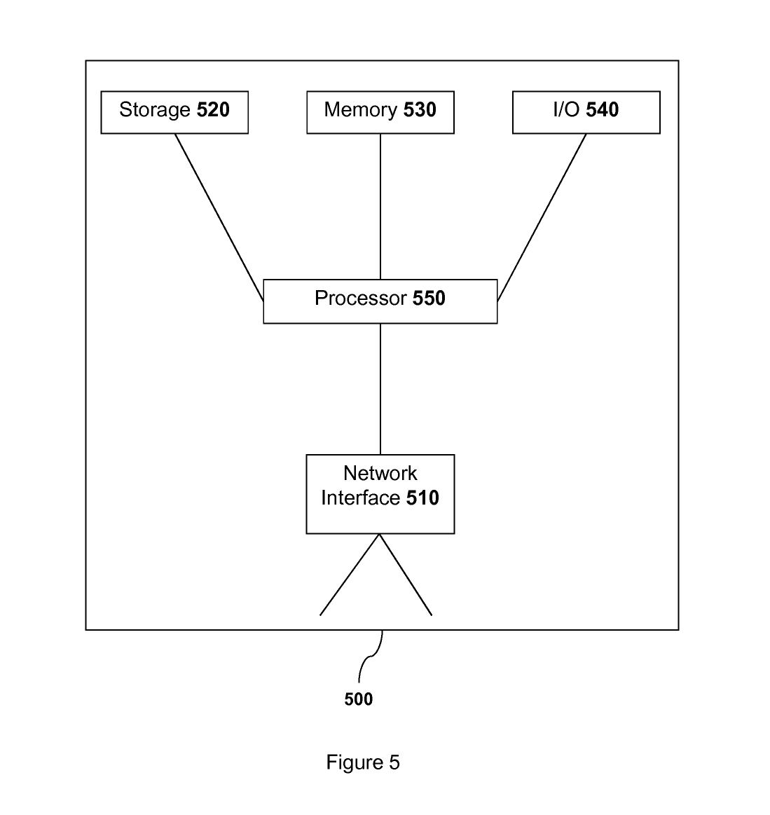

FIG. 5 is a high-level block diagram of a microprocessor device that may be used to carry out the disclosed technology. The device 500 may be employed to control electronic or automated components of the disclosed technology. The device 500 comprises a processor 550 that controls the overall operation of a computer by executing the system's program instructions which define such operation. The system's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 5 is a high level representation of some of the components of such a device for illustrative purposes. It should also be understood by one skilled in the art that the method and devices depicted in FIGS. 1 through 4 may be implemented, in whole or in part, on a device such as is shown in FIG. 5.

While it is obvious that modification or proper change and combination can be made to the present biological chip system according to the present invention by those skilled in the art, however, without departing from the contents, spirit and scope of the invention, any variations that are intended to achieve the techniques disclosed in the present invention should be within the scope of this invention. Specifically, it should be pointed out that all similar substitutions and modifications are obvious to those skilled in the art, and they are deemed to be within the scope and content of the present invention.

It is to be understood that the foregoing detailed description and accompanying drawings relate to a preferred illustrative embodiment of the invention. However, various changes and modifications may be made without departing from the spirit and scope of the invention. Accordingly, the present invention is not limited to the specific arrangements as shown in the drawings and described in detail herein above. The exemplary materials, constructions and illustrations included in the preferred embodiment and this patent application should therefore not be construed to limit the scope of the present invention, which is defined by the appended claims.

While the disclosed invention has been taught with specific reference to the above embodiments, a person having ordinary skill in the art will recognize that changes may be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A system for processing copper with coating material, comprising:
a housing;
an input interface for receiving incoming copper wires, wherein the input interface is connected to the housing;
an output interface for ejecting processed copper wires, wherein the output interface is connected to the housing;
an evaporation zone disposed in the housing, wherein the evaporation zone is connected to the input interface;
a solid-state area disposed in the housing, the solid-state area connected to the output interface;
a combustion chamber disposed in the housing, wherein the combustion chamber processes gases produced in the evaporation zone;
an exhaust gas tube directing the processed gases from the combustion chamber, wherein the exhaust gas tube is disposed in the housing;
a first returning pipe connected to the exhaust gas tube, wherein the first returning pipe directs the processed gases to the combustion chamber;
a second returning pipe connected to the exhaust gas tube, wherein the second returning pipe directs the processed gases to the evaporation zone; and
a third returning pipe connected to the exhaust gas tube, wherein the third returning pipe directs the processed gases to the solid-state area.

2. The system of claim 1, further comprising:
an airflow director directing the processed gases from the combustion chamber to the exhaust gas tube.

3. The system of claim 1, further comprising:
an exhaust pipe mounted on top of the housing, the exhaust pipe being connected an exhaust gas collecting area;
an air concentrator installed in the exhaust gas collecting area;
a heating layer on a surface of the air concentrator, wherein the heating layer conducts heat transfer between the air concentrator and the processed gases;
a steam generator attached to the air concentrator;
a water tank attached to the steam generator;
a vapor output pipe attached to the steam generator; and
a vapor balancing pipe attached to the water tank.

4. The system of claim 3, wherein the water tank further comprises a tank level alarm device.

5. The system of claim 3, wherein the water tank further comprises a drainage system for preventing liquid overflow, further wherein the drainage system has a floating element mounted on a side in the water tank, the floating element connected to a switch to control engagement of the water tank.

6. The system of claim 1, wherein the housing further comprises:
a confined and isolated air cooling area, the air cooling area further comprising:
a warm air outlet installed on a side of the input interface;
a gas exhaust pipe mounted on a top side of the housing for conducting heat transfer with a cool air circulating pipe; and
a hot air duct connected between the cool air circulating pipe and the hot air duct.

7. The system of claim 6, wherein the hot air duct has at least one electric heater and at least one heat sensor.

8. The system of claim 1, wherein the housing has an exhaust treatment system, wherein the exhaust treatment system employs the combustion chamber, the exhaust pipe, further wherein the exhaust treatment system has a sub-system disposed in the combustion chamber having a heating pipe, and a catalytic combustion tank.

9. The system of claim 8, wherein an entry of the catalytic combustion tank has a catalytic tank door, further wherein the catalytic combustion tank has an air filter and a catalytic combustion block, the catalytic combustion block having an air circulation gap for air flow circulation.

10. The system of claim 8, further comprising:
an exhaust pipe is connected between the combustion chamber and the catalytic combustion tank.
